(19) United States
(12) Patent Application Publication
(10) Pub. No.: US 2004/0056119 A1
(43) Pub. Date: Mar. 25, 2004

(54) Fuel injection valve for an internal combustion engine

(76) Inventors: Andreas Fath, Erlangen (DE); Wendelin Klugl, Seubersdorf (DE); Eberhard Kull, Pfaffenhofen (DE); Hakan Yalcin, Neu-Ulm (DE)

Correspondence Address: BAKER BOTTS L.L.P., PATENT DEPARTMENT, 98 SAN JACINTO BLVD., SUITE 1500, AUSTIN, TX, 78701-4039, US

(21) Appl. No.: 10/634,276

(22) Filed: Aug. 5, 2003

Related U.S. Application Data
(63) Continuation of application No. PCT/DE02/00417, filed on Feb. 5, 2002.

(30) Foreign Application Priority Data
Aug. 2, 2001 (DE) 10105681.8

(51) Int. Cl. F02M 61/00

(52) U.S. Cl. 239/533.12

(57) ABSTRACT

A fuel injection valve comprising a nozzle body (8) having a nozzle body seat (18), and a nozzle needle (2) is disclosed which is guided into the nozzle body (8) in a sealed manner and which comprises a nozzle needle shaft (6) and a nozzle needle seat (12). The nozzle body seat (18) and the nozzle needle seat (12) together form a sealed seat (20). A gap (28) is provided between the sealed seat (20) and the nozzle needle shaft (6). An outer surface (25) of the nozzle needle (2) extends in the region of the gap (28) essentially parallel to an inner surface (26) of the nozzle body (8).

### CROSS REFERENCE TO RELATED APPLICATION

This application is a continuation of copending International Application No. PCT/DE02/00417 filed Feb. 5, 2002 and claiming a priority date of Feb. 8, 2001, which designates the United States.

### TECHNICAL FIELD OF THE INVENTION

The present invention relates to a fuel injection valve.

### BACKGROUND OF THE INVENTION

WO 96/19661 discloses a fuel injection valve having a nozzle body with a central guide bore in which a nozzle needle is guided. Axial movement of the nozzle needle causes opening of the valve which is formed by a sealing edge at the nozzle needle seat of the nozzle needle and a conical nozzle body seat at the nozzle tip of the nozzle body. The nozzle needle seat and the nozzle body seat therefore cooperate and form a sealed seat. The valve controls the flow of fuel to the injection holes provided in the nozzle tip. When the valve closes, the sealing edge of the nozzle needle strikes the nozzle body seat forcibly, causing powerful mechanical stressing of the nozzle body which can result in reduced service life of the nozzle body. A shoulder in the form of a circumferential groove is therefore provided below the sealing edge of the nozzle needle in the sealed seat in order to prevent wear-induced alteration of the nozzle body seat diameter.

Seat wear can affect the injection quantity, flow characteristics and tightness of fuel injection valves. It is important to ensure the tightness of the injection valve particularly in the case of common rail injection systems, as these, in contrast to periodic injection, are permanently under peak system pressure, so that leakages would result in continuous injection.

To ensure that the fuel can flow to the injection holes, a clearance is provided between the front free end of the nozzle needle and an inner wall of the nozzle body. With the valve closed, when the sealing edge of the nozzle needle rests against the nozzle body seat of the nozzle body, this centers the nozzle needle in the nozzle body. However, when the nozzle needle lifts from the conical sealing surface, the nozzle needle then projecting freely into the tip of the nozzle body tends to deviate from its precisely centered position. This means that the injection holes are not evenly cleared, which in turn results in asymmetrical flow which adversely affects the emission values during the combustion sequence. This disadvantage occurs particularly with common rail injection systems with pre-injection. The pre-injection of a very small amount of fuel prior to the actual main injection improves the combustion process in terms of noise generation and exhaust behavior in such systems. Because of the small amount of fuel, the nozzle needle lifts off only very little from its seat in the nozzle body during pre-injection. Centering errors therefore have a very severe effect on the flow characteristics of the injected fuel and the combustion process.

### SUMMARY OF THE INVENTION

The object of the invention is to create a fuel injection valve wherein, on the one hand, mechanical stressing of the nozzle body is reduced and, on the other, improved flow characteristics can be achieved.

This object can be achieved by a fuel injection valve comprising a nozzle body having a nozzle body seat, and a nozzle needle tightly guided in the nozzle body and incorporating a nozzle needle shaft and a nozzle needle seat, wherein the nozzle body seat and the nozzle needle seat together forming a sealed seat, wherein a gap is provided axially in height between the sealed seat and the nozzle needle shaft, and wherein an outer surface of the nozzle needle runs essentially parallel to an inner surface of the nozzle body in the region of the gap.

The gap can be implemented as an elongated recess in the nozzle needle and/or the nozzle body. The gap may-adjoin a sealing edge of the nozzle needle seat. The sealing edge can be provided on a circumferential cylindrical needle section between a nozzle needle tip and a frusto-conical body section of the nozzle needle. The outer surfaces of the conical nozzle needle tip and of the frusto-conical body section of the nozzle needle each may have essentially the same included angle.

Accordingly there is provided, in the fuel injection valve, a gap which is disposed axially in the vertical plane between the sealed seat and a nozzle needle shaft when the valve is in the closed condition. The nozzle needle has between its nozzle needle tip and its cylindrical nozzle needle shaft a frusto-conical body section along whose longitudinal extent the gap runs at least sectionally. At the transition from the nozzle needle tip to the frusto-conical body section of the nozzle needle there is provided the nozzle needle seat which forms the sealed seat in conjunction with a conical nozzle body seat of a nozzle tip of a nozzle body when the valve is closed. The gap extending from the sealed seat in the direction of the nozzle needle shaft is designed in such a way that an external surface of the frusto-conical body section of the nozzle needle essentially runs parallel to an opposite internal surface of the nozzle body in the region of the gap. On closing of the fuel injection valve, when the nozzle needle seat impacts the nozzle body seat, fuel is dammed up in the gap above the sealed seat between the conical outer surface of the nozzle needle and the conical inner surface of the nozzle body and then forced out. Due to the fuel dammed up in the gap above the sealed seat when the valve is closed, on the one hand the impact energy of the nozzle needle in the nozzle body seat is hydraulically damped so that the mechanical stressing of the nozzle body and the resultant seat wear is reduced. Consequently a damping of the closure process is achieved in the region above the sealed seat. On the other hand, the nozzle needle is hydraulically guided by the fuel flowing into the gap during closure. This ensures precise centering of the nozzle needle in the nozzle body, as the fuel in the gap exerts on the nozzle needle an evenly distributed compressive force along the outer surface of the nozzle needle. This hydraulic guiding of the nozzle needle enables the injection holes to be evenly supplied with fuel, thereby ensuring improved flow characteristics of the fuel injected through the injection holes into the combustion chamber of the internal combustion engine.

For the design of the circumferential gap between the outer surface of the frusto-conical body section of the nozzle needle and a section of the inner surface of the nozzle body, it is preferred that the gap is implemented as an elongated recess in the outer surface of the nozzle needle and/or of the inner surface of the nozzle body. A recess of this kind is easily and precisely manufacturable.

To implement the hydraulic guide for the nozzle needle, it has been found advantageous if the circumferential gap directly adjoins the sealing edge of the nozzle needle seat. In addition, in disposing the gap above the sealing edge, a clearance volume below the sealed seat is minimized so that hydrocarbon emissions are reduced.

The sealing edge is preferably provided at a circumferential cylindrical needle section between a nozzle needle tip and a frusto-conical body section of the nozzle needle, the cylindrical needle section forming a circumferential shoulder above the sealing edge on the outer surface of the nozzle needle. In this way the gap which, with the valve closed, extends between nozzle needle and nozzle body from the cylindrical needle section at least sectionally along the outer surface of the frustoconical body section of the nozzle needle in the direction of the nozzle needle shaft, is easy and inexpensive to manufacture in the fuel injection valve.

Preferably the conical surfaces of the conical nozzle needle tip and of the frusto-conical body section of the nozzle needle in each case exhibit essentially the same included angle. By providing the cylindrical needle section between nozzle needle tip and frusto-conical body section, it can be ensured that the outer surface of the nozzle needle in the region of the gap runs essentially parallel to the inner surface of the nozzle body in the region of the gap.

### BRIEF DESCRIPTION OF THE DRAWINGS

The invention will now be explained in greater detail with reference to exemplary embodiments illustrated in the accompanying drawings:

FIG. 1 shows a longitudinal section through a first embodiment of the fuel injection valve according to the invention with a detail X;

FIG. 2 shows the detail X of FIG. 1 in enlarged form with another detail Y;

FIG. 3 shows the detail Y of FIG. 2 in enlarged form; and

FIG. 4 shows a section through a second embodiment of the fuel injection valve according to the invention.

### DETAILED DESCRIPTION OF THE PREFERRED EMBODIMENTS

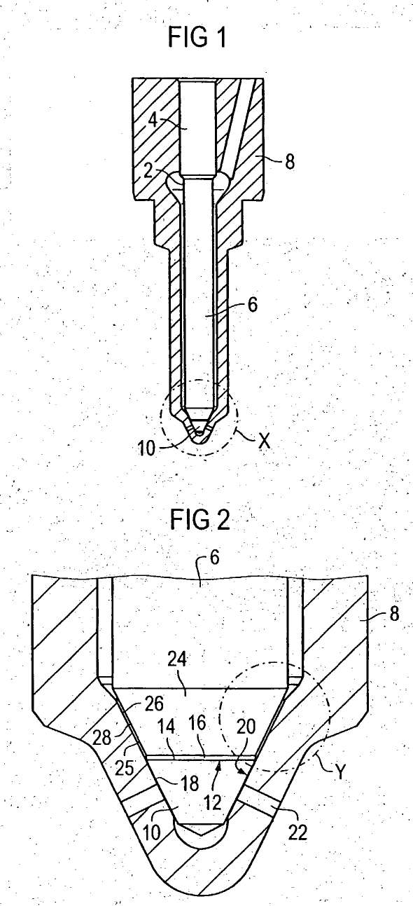

FIG. 1 shows a nozzle needle 2 with a nozzle needle guide 4 and a nozzle needle shaft 6 and which is guided tightly in a nozzle body 8. At the free end of the nozzle needle shaft 6 is located a nozzle needle tip 10 designated as detail X and shown in enlarged form in FIG. 2. It has a nozzle needle seat 12 with a sealing edge 14 which is defined by a circumferential cylindrical needle section 16. The nozzle needle seat 12 and a nozzle body seat 18 disposed on the nozzle body 8 cooperate in sealing the fuel injection valve and form the valve. The fuel injection valve is shown in the closed condition in which the sealing edge 14 together with the conical nozzle body seat 18 provides a sealed seat 20. Depending on the axial position of the nozzle needle 2 in the nozzle body 8, the valve controls the flow of fuel to injection holes 22 disposed below the sealed seat 20 in the direction of the nozzle needle tip 10.

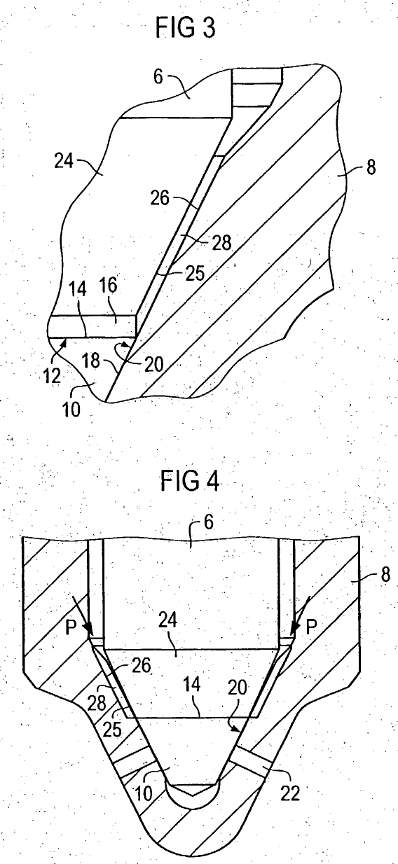

In an area between the sealed seat 20 and the nozzle needle shaft 6, a frusto-conical body section 24 of the nozzle needle 2 is discernible, the cylindrical needle section 16 being implemented at a transition between the nozzle needle tip 10 and the frusto-conical body section 24. Between a section of an inner surface 26 of the nozzle body 8 and an opposite section of an outer surface 24 of the frusto-conical body section 24 of the nozzle needle 2 there is additionally disposed a gap 28 which acts as a squish gap. This is shown as detail Y and is illustrated in enlarged form in FIG. 3.

As shown in FIG. 3, the outer surface 25 of the nozzle needle 2 essentially runs parallel to the inner surface 26 of the nozzle body 8, so that the gap 28 is implemented between the body section 24 of the nozzle needle and a section of the inner surface 26 of the nozzle body 8, the outer surface of the nozzle needle 2 having essentially the same included angle as the outer surface of the conical nozzle needle tip 12. The gap 28 extends from the sealed seat 20 along a predetermined region of the body section 24 of the nozzle needle 2 in the direction of the nozzle needle shaft 6. The gap 28 is therefore provided above the sealed seat 20 on the nozzle needle 2. In the outer surface 25 of the nozzle needle 2, the cylindrical needle section 16 therefore forms a circumferential shoulder which, in the illustrated closed position of the valve, seals the gap 28 at its lower end.

During closing of the fuel injection valve, when the nozzle needle 2 moves axially in the direction of the tip of the nozzle body 8, the sealing edge 14 strikes the conical nozzle body seat 18, causing the nozzle body seat 18 to wear. This seat wear depends on the force of the impact of the sealing edge 14 on the nozzle body seat 18. Due to the parallel arrangement of the outer surface 25 of the nozzle needle 2 and the inner surface 26 of the nozzle body 8 in the region of the gap 28, the fuel is forced out of the gap 28 shortly before the sealing edge 14 impacts the nozzle body seat 18, resulting in hydraulic damping of the wearing movement in the region above the sealed seat 20 on the nozzle needle 2. This reduces the impact force of the sealing edge 14 on the nozzle body seat 18 and therefore the seat wear.

In addition, the fuel forced into the gap 28 along the outer surface 25 of the nozzle needle 2 exerts an even compressive force on the nozzle needle 2. This results in a radial stabilization and centering of the nozzle needle 2, as the fuel in the gap 28 is quickly and evenly distributed and exerts a radial stabilizing force on the nozzle needle 2. With the precise centering of the nozzle needle thereby achieved, the flow of the injected fuel is significantly improved.

In contrast to FIG. 3, in the case of the fuel injection valve shown in FIG. 4 the gap 28 is incorporated in the nozzle body 8, said gap 28 being implemented as an elongated recess in the nozzle body 8. The fuel flows in the direction of the arrow P into the upper end of the circumferential recess and is forced into the gap 28 between the outer surface of the frusto-conical body section 24 of the nozzle needle and the opposite section of the inner surface 26 of the nozzle body 8 when the valve closes, the axial movement of the nozzle needle 2 being damped and the nozzle needle 2 being simultaneously hydraulically guided and precisely centered by the fuel pressure in the circumferential gap 28.

The preferred maximum clearance in the gap 28 between the outer surface 25 of the nozzle needle 2 and the inner surface 26 of the nozzle body 8 is in the region of 5 to 30 μm. Claims

1. Fuel injection valve comprising:
a nozzle body having a nozzle body seat, and
a nozzle needle tightly guided in the nozzle body and incorporating a nozzle needle shaft and a nozzle needle seat,
wherein the nozzle body seat and the nozzle needle seat together forming a sealed seat,
wherein a gap is provided axially in height between the sealed seat and the nozzle needle shaft, and wherein an outer surface of the nozzle needle runs essentially parallel to an inner surface of the nozzle body in the region of the gap.

2. Fuel injection valve according to claim 1, wherein the gap is implemented as an elongated recess in the nozzle needle and/or the nozzle body.

3. Fuel injection valve according to claim 1, wherein the gap adjoins a sealing edge of the nozzle needle seat.

4. Fuel injection valve according to claim 1, wherein the sealing edge is provided on a circumferential cylindrical needle section between a nozzle needle tip and a frusto-conical body section of the nozzle needle.

5. Fuel injection valve according to claim 4, wherein the outer surfaces of the conical nozzle needle tip and of the frusto-conical body section of the nozzle needle each have essentially the same included angle.

6. Fuel injection valve comprising:
a nozzle body having a nozzle body seat,
a nozzle needle tightly guided in the nozzle body and incorporating a nozzle needle shaft and a nozzle needle seat,
a sealed seat formed by the nozzle body seat and the nozzle needle seat,
a gap axially in height between the sealed seat and the nozzle needle shaft, and
an outer surface of the nozzle needle running essentially parallel to an inner surface of the nozzle body in the region of the gap.

7. Fuel injection valve according to claim 6, wherein the gap is implemented as an elongated recess in the nozzle needle and/or the nozzle body.

8. Fuel injection valve according to claim 6, wherein the gap adjoins a sealing edge of the nozzle needle seat.

9. Fuel injection valve according to claim 6, wherein the sealing edge is provided on a circumferential cylindrical needle section between a nozzle needle tip and a frusto-conical body section of the nozzle needle.

10. Fuel injection valve according to claim 9, wherein the outer surfaces of the conical nozzle needle tip and of the frusto-conical body section of the nozzle needle each have essentially the same included angle.
